(19) United States
(12) Patent Application Publication
(10) Pub. No.: US 2010/0223223 A1
(43) Pub. Date: Sep. 2, 2010

(54) METHOD OF ANALYZING AUDIO, MUSIC OR VIDEO DATA

(75) Inventors: Mark Sandler, London (GB); Yves Raimond, London (GB); Samer Abdallah, London (GB)

Correspondence Address: FOX ROTHSCHILD LLP, 997 Lenox Drive, Building 3, Lawrenceville, NJ, 08648, US

(73) Assignee: QUEEN OF MARY AND WESTFIELD COLLEGE UNIVERSTIY OF LONDON, London (GB)

(21) Appl. No.: 11/917,601

(22) PCT Filed: Jun. 19, 2006
(86) PCT No.: PCT/GB06/02225

§ 371 Date: May 24, 2010

(30) Foreign Application Priority Data
Jun. 17, 2005 (GB) 0512435.9

(51) Int. Cl. G06N 5/02

(52) U.S. Cl. 706/50; 706/58

(57) ABSTRACT

Meta-data or tags are generated by analysing audio, music or video data; a database stores audio, music or video data; and a processing unit analyses the data to generate the meta-data in conformance with an ontology. Ontology-based approaches are new in this context. A logical processing unit infers knowledge from the meta-data.

### BACKGROUND OF THE INVENTION

1. Field of the Invention

Information management and retrieval systems are becoming an increasingly important part of music, audio and video related technologies, ranging from the management of personal music collections (e.g. with ID3 tags or in an iTunes database), through to the construction of large ‘semantic’ databases intended to support complex queries, involving concepts like mood and genre as well as lower-level or textual attributes like tempo, composer and director. One of the key problems is the gap between the development of stand-alone multimedia processing algorithms (such as feature extraction or compression) and knowledge management technologies. Current computational systems will often produce a large amount of intermediate data; in any case, the combined multiplicities of source signals, alternate computational strategies, and free parameters will very quickly generate a large result-set with its own information management problems.

We aim to provide, in one implementation, a framework which is able to bridge this gap, semi-automatically integrating music, audio and video (multimedia) analysis and processing in a distributed information management system. We deal with two principal needs: management of multimedia content-related information (commonly termed metadata) and of the computational system used to analyze the multimedia content. This leads to the idea of a “software laboratory workbench” providing large sets of annotated (music) content collections, and the logical structure required to build reusable, persistent collections of analysis results. For example, computing a spectogram returns a simple array of numbers, which has a limited meaning. It is better to know that it was computed by a spectrogram function, as this constraints the space of specific functions that could have been used. Moreover, adding a more precise specification, like the hop size, the frequency range or the source signal, increases the semantic value: the array is now related to time and frequency, and to a signal.

In order to achieve this goal, we introduce several concepts, leading to the definition of a so-called Knowledge Machine. Knowledge Machines provide a work-space for encapsulating multimedia processing algorithms, and working on them (testing them or combining them). Instances of Knowledge Machines can interact with a shared and distributed knowledge environment, based on Semantic Web technologies. This interaction can either be to request knowledge from the environment, or to dynamically contribute to the environment with new knowledge.

2. Description of the Prior Art

2.1 Approaches to Content Production and Content Description

Consider the following scenario: we have a collection of raw data in the form of recorded signals, audio or video data. We also have information about the physical circumstances surrounding the recording of each signal, such the time and place, the equipment used, the people involved, descriptions of the events depicted in the signals, and so on. Our first task is to represent this ‘circumstantial’ information in a flexible and general way.

2.2 Metadata

Metadata (Greek meta “over” and Latin data “information”, literally “data about data”), are data that describe other data. Generally, a set of metadata describe a single set of data, called a resource. An everyday equivalent of simple metadata is a library catalog card that contains data about a book, e.g. the author, the title of the book and its publisher. These simplify and enrich searching for particular book or locating it within the library (definition from Wikipedia).

One option is to ‘tag’ each piece of primary data with further data, commonly termed ‘metadata’, pertaining to its creation. For example, CDDB associates textual data with a CD, while ID3 tags allow information to be attached to an MP3 file. The difficulty with this approach is the implicit hierarchy of data and metadata. The problem becomes acute if the metadata (eg the artist) has its own ‘meta-metadata’ (such as a date of birth). If two songs are by the same artist, a purely hierarchical data structure cannot ensure that the ‘meta-metadata’ for each instance of an artist agree. This is illustrated in FIG. 1. The obvious solution is to keep a separate list of artists and their details, to which the song metadata now refers. The further we go in this direction, creating new first-class entities for people, songs, albums, record labels, the more we approach a fully relational data structure, as illustrated in FIG. 2.

A common way to represent metadata about multimedia resources is to use the MPEG-7 specification. But MPEG-7 poses several problems. First, information is still built upon a rigid hierarchy. The second problem is that MPEG-7 is only a syntactic specification: there is no defined logical structure. This means that there is no support for automatic reasoning on multimedia-related information, although there have been attempts to build a logic-based description of MPEG-7 [Hunter, 2001].

2.3 Flat Data Dictionary

Now consider a scenario where, as well as collection of signals, we also have a number algorithms we can apply to the signals in order to compute features of interest. The algorithms may be modular and share intermediate steps, such as the computation of a spectrogram or the fitting of a hidden Markov model, and they may also have a number of free parameters.

The data resulting from these computations is often managed as a dictionary of key-value pairs. Values are processing-related informations (variables of different types, files) and keys are simple ways to access them (by the name of the files or associated variables names, for example). This may take form of named variables in a Matlab workspace, files in a directory, or files in a directory tree. This can lead to a situation in which, after a Matlab session, one is left with a workspace full of objects but no idea how each one was computed, other than, perhaps, clues in the form of the variable names one has chosen. The semantic content of these data, such as it is, is intimately tied to knowledge about which function computed which result using what parameters, and so one might attempt to ameliorate the problem by using increasingly elaborate naming schemes, encoding information about the functions and parameters into the keys, but once again, this is but a step towards a relational structure where such information can be represented explicitly and in a consistent way.

2.3.2 Tree-Based Organization

A more sophisticated way of dealing with computational data is to organize them in a tree-based structure, such as a file system with directories and sub-directories. By using such an organization, one level of semantics is added to data, depending on where the directories and sub-directories are located in this tree. Each directory can represent one class of object (to describe a class hierarchy), and files in a directory can represent instantiations of this class. But this approach is quite limited, quickly resulting in a very complex directory structure. Moreover, as in a flat organization, you can adopt a naming convention to be able to identify two different instantiations of one class. Importantly, there is no relational structure between the different elements, and between these elements and a larger information structure, to express where the data come from, what they are dealing with, and so on. Because relationships can only be expressed as simple hierarchies, data cannot be accessed from their relationship to other data. In recognition of these limitations, symbolic links can be introduced into hierarchical structures, in order to deal with multiple instantiation or multiple inheritance. But this measure does not solve all the problems of hierarchical/tree-structured data.

By organising data in a tree, a level of semantics can be added since some of the relationships between values can be inferred from their relative positions in the tree. However this mechanism can represent only one such relationship, and only those that are naturally tree-structured. Any other relationships must be represented some other way.

2.4 A Need for a Logic-Based Relational Model

Both of the scenarios mentioned above point to a relational data model where different relations are used to model the connections between signals, ‘upstream’ (i.e. prior to processing) circumstantial data, and ‘downstream’ (after the processing) derived data. Here we introduce the concept of ‘tuples’ by which we means a set of values in a specific order, eg a pair, a triple. Although strictly speaking, the following section is not ‘prior-art’ we include it here for clarity.

Tuples in these relations represent propositions such as ‘this signal is a recording of this song at this sampling rate’, or ‘this spectrogram was computed from this signal using these parameters’. From here, it is a small step to go beyond a relational database to a deductive database, where logical predicates are the basic representational tool, and information can be represented either as facts or inference rules. For example, if a query requests spectrograms of wind music, a spectrogram of a recording of an oboe performance could be retrieved by making a chain of deductions based on some general rules encoded as logical formula, such as ‘if x is an oboe, then x is a wind instrument’. A relational data structure is needed in order to express the relationships between objects in the field of this patent. A single description framework will therefore be able to express the links between concepts of music and analysis concepts. However, a relational structure (like a set of SQL tables) alone is not sufficient. It is necessary to be able to understand user queries, to provide the most accurate result. For this the framework needs to include a logic-based structure. This enables new facts to be derived from prior knowledge, and to make explicit what was implicit. Finally, by describing the different components of the facts as instances of an ontology (a specification of conceptualization), the system becomes able to reason on concepts, not only on unique objects. This framework will enable a system to reason on explicit data, in order to make implicit data accessible by the user.

2.5 Logic Processing

In this section we explain how to deal with the derivation of facts, using a logic-based structure.

The propositional calculus provides a formal mechanism for reasoning about statements built using atomic propositions and logical connectives. An atomic proposition is a symbol, p or q, standing for something which may be true or false, such as ‘guitars have 6 strings’ and ‘guitar is an instrument.

The logical connectives v (or), Λ (and), [symbol] (not), ⊃ (implies), ≡ (equivalence) can be used to build composite formula such as [symbol] p (not p) and p⊃q (p implies q). Given a collection of axioms, new statements consistent with the axioms can be deduced, such as ‘a guitar is an instrument and a guitar has 6 strings’. Thus, a knowledge-base could be represented as a set of axioms, and questions of the form ‘is it true that . . . ?’ can be answered by attempting to prove or disprove the query.

The propositional calculus is rather limited in the sort of knowledge it can represent, because the internal structure of the atomic propositions, evident in their natural language form, is hidden from the logic. It is clear that the propositions given above concern certain objects which may have certain properties, but there is no way to express these concepts within the logic.

The predicate calculus extends the propositional calculus by introducing both a domain of objects and a way to express statements about these objects using predicates, which are essentially parameterised propositions. For example, given the binary predicate strings and a domain of objects which includes the individuals guitar and violin as well as the natural numbers, the formulæ strings(guitar, 6) and strings(violin, 4) express propositions about the numbers of strings those instruments have.

The introduction of variables and quantification increases the power of the language yet more. For example, the two examples of atomic propositions given at the beginning of the section can be expressed as

∀x.orchestralStrings(x)⊃strings(x,4)

orchestralStrings(violin)

where x is a variable which ranges over all objects in the domain. In this form they are much more amenable to automatic reasoning; for example, we can infer strings(violin, 4) as a logical consequence of the above two axioms. We can also pose queries using this language. For example, we can ask, ‘which (if any) objects have 4 strings?’ as [symbol] x.strings(x,4)

An inference engine would attempt to prove this by searching for objects in the domain for which strings(x,4) is true. In this way, a query can retrieve data satisfying given constraints, which is necessary for a practical information management system of the type described in this specification.

The logic-based language is more powerful than the SQL commonly used to access a relational database management system, but nonetheless, each predicate can be likened to a table in a database, with each tuple of values for which the predicate is true corresponding to a row in the table. The calculus allows predicates to be defined using rules rather than as an explicit set of tuples, but these rules can be more complex than those allowed in SQL views.

A large part of building a logic-based information system is deciding what types of objects are going to be in the domain of discourse and what predicates are going to be relevant. Designing an ontology of the domain involves identifying the important concepts and relations, and as such can help to bring some order to the potentially chaotic collection of predicates that could be defined. In providing an ontology, we can also provide a practical method for implementing a sub-set of predicate calculus, known as Description Logic.

An ontology is an explicit specification of the concepts, entities and relationships in some domain—refer to FIG. 3 for an example relevant to music. By specifying conceptualization in these domains, you allow a system to deal, no longer with symbols, but with concept-related information. Moreover, an ontological specification contains by itself some inference rules, related to what you can deduce from the conceptual structure and from the associated relational structure.

Concerning the conceptual structure, we develop our previous example. If you define the class keyboard instrument as a subclass of instrument, an individual of the first class will be also contained in the second. Moreover, you can state a class as a defined class. It contains all the instances verifying some relationships with others.

A Description Logic is a formal language for stating these specifications as a collection of axioms. They can be used, as in this simple example, to derive conclusions, which are essentially theorems of the logic. This can be done automatically using logic-programming techniques as in Prolog.

The class hierarchy in a Description Logic implies an is a relationship between entities, or a successive specialization or narrowing of some concept, for example ‘a piano is a keyboard instrument’ or ‘all pianos are also keyboard instruments’. Classes need not form a strict tree. As a predicate calculus formula, this is a relation states an implication between two unary predicates:

piano(x)⊃keyboardinstr(x)

i.e., ‘if x is a piano, then x is a keyboard instrument’. A model of this theory will include, two sets, say P and K (called the extensions of the classes) such that P⊃K.

Properties in Description Logic are defined as binary predicates with a domain and a range, which correspond to binary relations. For instance, if plays is a property whose domain is Person and range is Instrument, then

x.plays.y⊃Person(x)Λ Instrument(y)

We can now support reasoning such as ‘if x plays a piano, then x plays a keyboard instrument.’

The extension of the plays property is a relation

ℑ (plays)⊂ℑ (Person)×ℑ (Instrument)

(where the interpretation mapping ℑ denotes extensions). Properties can be declared to be transitive, function, or inverse functional.

Description logic also has the concept of defined classes. If we wish to state that a composer is someone who composes musical works, we express this concept as

Composer≡ [symbol] composed.Opus

or alternatively, as a formula in the predicate calculus,

composer(x)≡ [symbol] y.opus(y) Λ composed(x,y)

This can be useful as it results in automatic classification on the basis of concrete properties.

These properties of predicate calculus and description logic provide the means to conceptualize over data via automatic reasoning. A natural mechanism to implement this is provided by two core technologies for representation in the Semantic Web, RDF (Resource Description Framework), and built on top of it, OWL (Ontology Web Language).

While the eXtended Markup Language (XML) was based upon a tree structure, RDF is based upon a more flexible graph structure. Nodes are called resources or literals, and edges are called properties. There are two types of resources: those located by an URI (Universal Resource Identifier—URLs are a subclass of URIs), and those called blank nodes or anonymous nodes which are nodes that do not correspond to a real resource. Literals correspond to dead-ends in the graph, and give information about the node they are attached to. RDF descriptions appear as a sequence of statements, expressed as triples {Subject, Predicate, Object} where subjects are resources and objects are either resources or literals. Predicates are also described as non-anonymous resources.

These RDF entities have no real semantics. We want to manipulate concepts, not only objects. This need can be seen as wanting to describe an abstract vocabulary for the sentences described as RDF triples. This vocabulary can be constructed using the Ontology Web Language, OWL. In particular we propose using OWL DL which includes Description Logics, expressed as RDF triples and provides a firm logical foundation for reasoning to take place.

An important benefit is that ontologies are shareable. By defining a controlled vocabulary for one (or several) specific domain, other ontologies can be referenced, or can refer to your ontology, as long as they conform to ontology modularization standards.

### SUMMARY OF THE INVENTION

This patent specification describes, in one implementation, a knowledge generation or information management system designed for audio, music and video applications. It provides a logic-based knowledge representation relevant to many fields, but in particular to the semantic analysis of musical audio, with applications to music retrieval systems, for example in large archives, personal collections, broadcast scenarios and content creation.

In a first aspect, the invention is a method of analysing audio, music or video data, comprising the steps of:
(1) a database storing audio, music or video data;
(2) a processing unit analysing the data to automatically generate the meta-data in conformance with an ontology to infer knowledge from the meta-data.

For example, it is possible to analyse a collection of Beatles songs to find the chord sequences in the recordings. From that, it is possible to infer the key signature, including modulations of that key. Hence, the ‘music data’ in this example is the song collection in digitised format; the high level ‘meta-data’ is a symbolic representation of a sequence of chords and the associated times that they are played (e.g. in XML). The chords that can be identified can be only those that appear in an ontology of music; so the ‘ontology’ includes that set of possible chords that can occur in Western music. The ‘knowledge’ inferred can include an inference of the musical key signature that the music is played in. Also, the ‘knowledge’ can include an inference of the single chord sequence, having the most probable occurrence likelihood, from a set of possible chord sequences covering a range of occurrence probabilities. Meta-data of this type, conforming to musicological knowledge (e.g. chord, bar/measure, key signature, chorus, movement etc.) are sometimes called annotations or descriptors. So, ‘knowledge’ can include an inference of the most likely descriptor of a piece of music, using the vocabulary of the ontology.

In one implementation, the meta-data is not merely a descriptor of the data, but is data itself, in the sense that it can be processed by a suitable processing unit. The processing unit itself can include a maths processing unit and a logic processing unit.

In another implementation, the data can be derived from an external source, such as the Internet; it can be in any representational form, including text. For example, a musicologist might post information on the Beatles, stating that the Beatles never composed in D sharp minor. We access that posting. It will be part of the ‘data’ that the processing unit analyses and constrains the knowledge inferences that are made by it. So the processing unit might, in identifying the most likely chord sequence, need to choose between an F sharp minor and a D sharp minor; using the data from the musicologist's web site, the processing unit can eliminate the D sharp minor possibility and output the F sharp minor as the most likely chord sequence.

The processing unit can store the meta-data in the database as further data, enabling the processing unit to analyse the further data to generate meta-data ('further data' has been described as ‘intermediate data’ earlier). Hence, returning to the last this example, the way to calculate chord sequences of Beatles songs includes, first, a spectral analysis step, leading then to the calculation of a so called chromagram. Both the spectral and the chromagram representation in some sense describe the music, i.e. they are descriptors of the music and, although numerically based, can be categorised as meta-data. Both these descriptors (and associated computational steps) may be saved in the database so that if needed for any future analysis, are available directly from the database. The chromagram itself is further processed to obtain the chord sequence.

If a user downloads these songs to his personal music player, some or all of these descriptors can be downloaded alongside the songs, although most benefit is likely to come from downloading only the key and possibly the chord sequences.

It is possible that a consumer owns many songs in digital format and would like to listen to this collection without having to determine exactly what song comes when; this is the concept of an automatically generated play list; the ‘knowledge’ is this play list. In order to do this, all of the collection will have been analysed by a processing unit operating according to the principles of the invention and descriptive meta-data for each song stored in a meta-data database. To meet the consumer's need, he identifies one or more ‘seed’ songs, whose meta-data is used by the processing unit to determine or infer a play list according to his preference (e.g. expressed as mood, location, activity etc.).

In a related scenario, the consumer wishes to find one or more tracks external to his collection that are in some sense similar or redolent to one or more tracks in the collection. The meta-data are descriptors of each song in his collection (e.g. conforming to MPEG 7 low level audio descriptors). Any external collection of songs (e.g. somewhere on the Web) which conforms to the same descriptor definitions, can be searched, automatically or otherwise. A composite profile is built across one or more song collections owned by the consumer and the processing unit matches that profile to external songs; a song that is close enough could then be added to his collection (e.g. by purchasing that song). The knowledge is hence the composite profile and also the identity and location of the song that is close enough.

Most music tracks are engineered in a recording studio; this is a creative process involving musicians, producers and sound engineers. Typically, each musician will separately record or have recorded his contribution. The result is that there is a collection of individual instrument recordings that need to be integrated and sound engineered to create the final product (also known as the ‘essence’). In another implementation, during individual instrument and vocal recordings, meta-data describing pitch sequences (melody), rhythm sequences, beats per minute, lead instrument, key etc. can be calculated or specified for each individual instrument recording by a processing unit operating according to the principles of the invention. When the final product is created, the meta-data for each song is similarly combined by the processing unit to provide a composite meta-data representation. This will amongst other things identify automatically where the chorus starts and stops, where verses start and stop etc., so inferring a structure for the musical piece. The knowledge generated is the inferred structure, as well as the melody descriptors, rhythm descriptors etc.

In another implementation, a research scientist is evaluating new ways to automatically transcribe recorded music as a musical score. Typical recordings are known as polyphonic because they include more than one instrument sound. As a first stage, he proposes to perform automatic source separation on a recording in order to extract approximations to individual instrument tracks. His collaborator, working in a different continent, has developed, using his own knowledge machine, new monophonic transcription algorithms. Our researcher is able to seamlessly evaluate the full transcription from the polyphonic original into individual instrument scores because his knowledge machine is aware of the services that can be provided by the collaborator's knowledge machine. The knowledge is the full symbolic score representation that results—i.e. knowing exactly what instrument is playing and when. The meta-data are the approximations to the individual music tracks (and symbolic representations of those tracks); therefore meta-data is also knowledge.

In another implementation, a major search engine has a 5 million song database. Users obviously need assistance in finding what they would like to hear. The user might be able to select one or more songs he knows in this database and because all the songs are described according to the music knowledge represented in a music ontology, it is straightforward for the service to offer several good suggestions for what they listener might choose to listen to. The user's selection of songs can be thought of as a query to this large database. The database is able to satisfy this query by matching against one or more musical descriptors (multi-dimensional similarity). For example, the user chooses several acoustic guitar folk songs, and is surprised to find among the suggestions generated by the search engine pieces of 17^{th} century lute music, which he listens to and likes, but had never before encountered. He buys the lute music track from the search engine or an affiliated web site. The meta-data are those musical descriptors used to match against the query. The knowledge is the new track(s) of music he did not know about. In a related example, when he buys a track from a web merchant site, that site can suggest other tracks he might like to consider buying; thr track bought is a query to the database of all tracks the merchant can sell.

All entities in a processing unit (also referred to as a knowledge machine) can be described by descriptors (i.e. a class of meta-data) conforming to an ontology; the entities include computations, the results of computations, inputs to those computations; these inputs and outputs can be data and meta-data of all levels. That is, all aspects of a knowledge machine are described. Because the knowledge machine includes logic that works on descriptors, all entities in a knowledge machine can be reasoned over. In this way, complex queries involving logical inference, as well as mathematics, can be resolved.

The ontology can be a collection of terms specific to the creation, production, recording, editing, delivery, consumption, processing of audio, video or music data and which provide semantic labels for the audio, music or video data and the meta-data. The ontology can include an ontology of one or more of the following: music, time, events, signals, computation, any other ontology available on the internet or the Semantic Web.

More specifically, the ontology of music includes one or more of:
(a) musical manifestations, such as opus, score, sound, signal;
(b) qualities of music, such as style, genre, form, key, tempo, metre
(c) Agents, such as person, group and role, such as engineer, producer, composer, performer;
(d) Instruments;
(e) Events, such as composition, arrangement, performance, recording
(f) Functions analysing existing data to create new data

The ontology of time includes time-point, moment, time interval, timeline, timeline mapping, co-ordinate systems. The ontology of time can use interval based temporal logics.

The ontology of events can includes event tokens representing specific events with time, place and an extensible set of other properties.

The ontology of signals can include sample, frame, signal fragment, acoustic, electronic, stereo, multi-channel, live, discrete and continuous time signals.

The ontology of computation can include Fourier transforms, filtering, onset detection, hidden Markov modelling, Bayesian inference, principal and independent component analyses, Viterbi decoding, and relevant parameters, callable computation, non-deterministic function, evaluation, computational events, computation time, argument types, access modes, determinism, evaluation events. It can also be dynamically modified.

Managing the computation can be achieved by using functional tabling, in which the computations and outcomes are stored in a database, in order to contribute to future computations.

The ontology can include an ontology of semantic matching, which associates an algorithm to one or more concepts and includes some or all of the following terms: predicate, Knowledge Machine, RDF triples, match.

In an implementation, temporal logic can be applied to reason about the processes and results of signal processing. Internal data models can then represent unambiguously temporal relationships between signal fragments in the database. Further, building on previous work on temporal logic by adding new types or descriptions of object is possible.

Other features in an implementation include:
Multiple time lines can be allowed for to support definitions of multiple related signals;
Time-line maps can be generated, handled or declared;
Knowledge extracted from the Semantic web is used in the processing to assist meta-data creation.
There can be several sets of databases, processing units and logical processing units, each on different user computers or other appropriately enabled devices;
the database is distributed across the Internet and/or Semantic Web;
there are several sets of databases, processing units and logical processing units, co-operating on a task.
Automatic deployment in a system used for the creation of artistic content; such a system can also manage various independent instrument recordings. The system can process related metadata to provide a single or integrated metadata representation that corresponds appropriately to a combination of the instrument recordings, whether raw or processed, that constitutes the musical work.
the meta-data analysed by the processing unit includes manually generated meta-data.
the meta-data analysed by the processing unit includes pre-existing meta-data.
the ontology includes a concept of ‘mode’ that allows relations to be declared as strictly functional when particular attributes are treated as ‘inputs’ and allows reasoning about legal ways to use the relations and how to optimise its use by tabling previous computations. The mode allows for a class of stochastic computations, where the outputs is defined by a conditional probability distribution.

Other aspects of the invention are:
A music, audio or video data file tagged with meta-data generated using the above methods;
A method of locating music, audio or video data by searching against meta-data generated using the above methods;
A method of purchasing music, audio or video data by locating the music, audio or video using the method of locating music defined above;
A database of music, audio, or video data tagged with meta-data generated using the above methods;
A personal media player storing music, audio, or video data tagged with meta-data generated using the above methods. This can be a mobile telephone.
A music, audio, or video data system that distributes files tagged with meta-data generated using the above methods;
Computer software programmed to perform the above methods.
A plug-in application that is adapted to perform the above methods, in which the database is provided by the client computer that the plug-in runs on.

In typical use, a user wants to navigate large quantities of structured data in a meaningful way, applying various forms of processing to the data, posing queries and so on. File hierarchies are inadequate to represent the data, and while relational databases are an improvement, there are limitations in the style of complex reasoning that they support. By incorporating intelligence in the form of logical representations and augmenting the data with rules to derive facts, a deductive database of the type described is more appropriate to the fields of application.

An implementation of the invention'unifies the representation of data with its metadata and all computations performed over either or both. It does this using the language of first-order predicate calculus, in terms of which we define a collection of predicates designed according to a formalised ontology covering both music production and computational analysis. By integrating these different facets within the same logical framework, we facilitate the design and execution of experiments, such as exploration of function parameter spaces, the forming of connections between given ‘semantic’ annotations and computed data.

Such a system can process real-world data (music, speech, time-series data, video, images, etc) to produce knowledge (that is, structured data), and further processes that knowledge (or other knowledge available on the Semantic Web or elsewhere) to deduce more knowledge and to deduce meaning relevant to the specific real-world data and queries about real-world data.

The system integrates data and computation, for complete management of computational analyses. It is founded on a functional view of computation, including first-order logic. There is a tight binding and integration of a logic processing engine (such as Prolog) with a mathematical engine (such as Matlab, or compiled C++ code, or interpreted Java code).

An important aspect of the system is its ontology, which enables the system to provide formal specifications which take the form of logical formulae. This is because the logical foundation of ontologies lead to well defined model-theoretic semantics. The ontology can be monolithic or can consist of several ontologies, for example, an ontology of music, an ontology of time, an ontology of events, an ontology of signals, an ontology of computation and ontologies otherwise available on the Internet.

As noted earlier, we refer to such a system as a Knowledge Machine (KM). It brings together the following: Logic programming, Semantic reasoning, Mathematical processing, a (relational) Database, an Ontology. This is shown in FIG. 4.

A user can provide complex, multi-attribute queries based on principles of formal logic, which among other things can
Generate an automatic analysis of music and multimedia content
Compute and manage large amounts of intermediate data including large result sets, so as to obviate the need to re-compute results (and intermediate results) relevant to the current query, if these were computed for a previous query
Use queries to define datasets and thus produce derived data pertaining to arbitrary subsets of the whole

### BRIEF DESCRIPTION OF THE DRAWINGS

The present invention will be described with reference to the accompanying Figures:

FIG. 1 Demonstrates that with current metadata solutions, there is no intrinsic way to know that a single artist produced two songs. The song is the level-one information (or essence), artist, length and title are level-two information (metadata) and there is level-three information (meta-metadata) associated with the artist description.

FIG. 2 With the same underlying level-one data as in FIG. 1 (the songs) this relational structure enables a system to capture the fact that the artist has two songs.

FIG. 3 Some of the top level classes in the music ontology together with sub-classes connected via “is-a” relationships.

FIG. 4 Overall Architecture of a Knowledge Machine.

FIG. 5 Overview of the Knowledge Machine framework.

FIG. 6 Examples of computational networks, (a) the computation of a spectrogram, (b) a structure typical of problems requiring statistical and learning models such as Hidden Markov Models.

FIG. 7 Planning using the semantic matching ontology.

FIG. 8 The multimedia Knowledge Management and Access Stack.

FIG. 9 Some events involved in a recording process. In this graph, the nodes represent specific objects rather than classes.

FIG. 10 XsbOWL: able to create a SPARQL end-point for multimedia applications.

FIG. 11 Part of the event class ontology in the music ontology. The dotted lines indicate sub-class relationships, while the labeled lines represent binary predicates relating objects of the two classes at either end of the line.

FIG. 12 An example of the relationships that can be defined between timelines using timeline maps. The continuous timeline h₀ is related to the three discrete timelines h₁, h₂, h₃. The dotted outlines show the images of the continuous time intervals a and b in the different timelines. On the left, the potential influence of values associated with interval a spreads out, while on the right, the discrete time intervals which depend solely on b get progressively narrower, until, on timeline h₃, there is no time point which is dependent on events within b alone.

FIG. 13 The objects and relationships involved in defining a discrete time signal. The signal is declared as a function of points on a discrete timeline, but it is defined relative to one or more coordinate systems using a series of fragments, which are functions on the coordinate spaces.

FIG. 14 Creating a SPARQL end-point to deal with automatic segmentation of Rolling Stones songs.

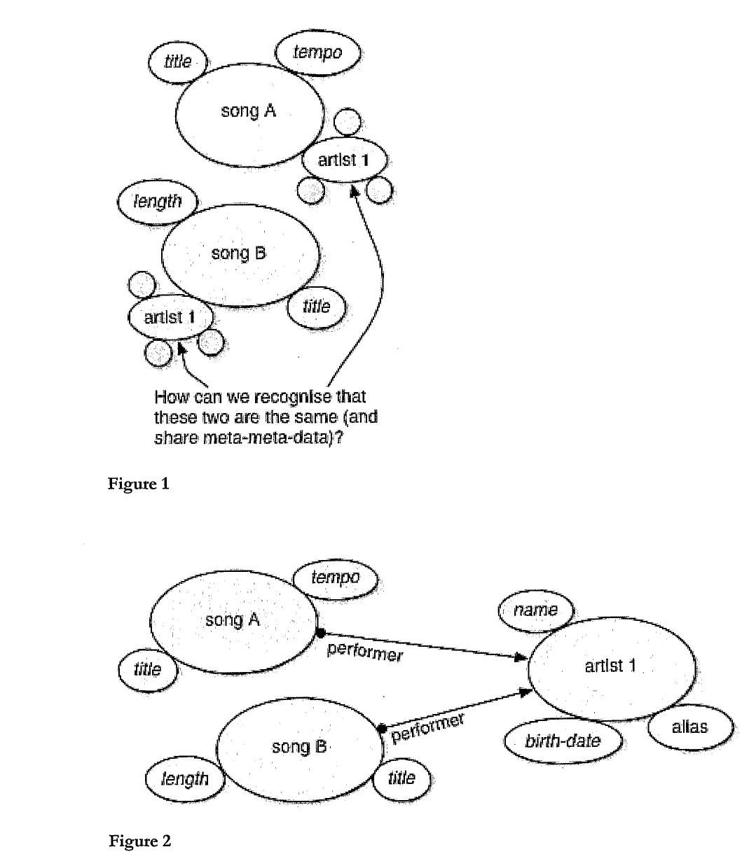

### DETAILED DESCRIPTION

### 1. General Overview

We describe a knowledge management framework that addresses the needs of multimedia analysis projects and provides an anchor for information retrieval systems. The framework uses Semantic Web technologies to provide a distributed knowledge environment, and active Knowledge Machines, wrapping multimedia processing tools, to exploit and/or contribute to this environment—see FIG. 5 for a high level view of the interaction of Knowledge Machines and the Internet or Semantic Web. This framework is modular and able to share intermediate steps in processing. It is applicable to a large range of use-cases, from an enhanced workspace for researchers to end-user information access. In such cases, the combination of source data, intermediate results, alternate computational strategies, and free parameters quickly generates a large result-set bringing significant information management problems.

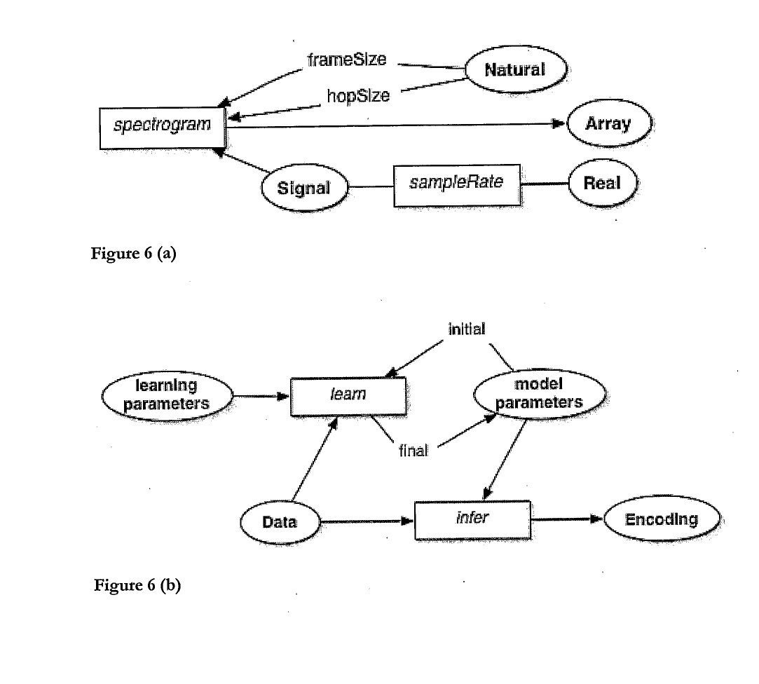

This scenario points to a relational data model, where different relations are used to model the connections between parameters, source data, intermediate data and results. Each tuple in these relations represents a proposition, such as ‘this spectrogram was computed from this signal using these parameters’ (see FIG. 6). From here, it is a small step to go beyond a relational model to a deductive model, where logical predicates are the basic representational tool, and information can be represented either as propositions or as inference rules.

A basic requirement for a music information system is to be able to represent all the ‘circumstantially’ related information pertaining to a piece of music and the various representations of that piece such as scores and audio recordings; that is, the information pertaining to the circumstances under which a piece of music or a recording was created. This includes physical times and places, the agents involved (like composers and performers), and the equipment involved (like musical instruments, microphones). To this we may add annotations like key, tempo, musical form (symphony, sonata).

The music information systems we use below as examples cover a broad range of concepts which are not just specific to music; for example, people and social bodies with, varying memberships, time and the need to reason about time, the description of physical events, signals and signal processing in general and not just of music signals, the relationship between information objects (like symbolic scores and digital signals) and physical manifestations of information objects (like a printed score or a physical sound), the representation of computational systems, and finally, the representation of probabilistic models including any data used to train them. In fact, once these non-music-specific domains have been brought together, only a few extra musical concepts need be defined in order to have a very comprehensive system.

### 2. Use Cases

In this section, we describe various use cases, in order to give an idea of the wide range of possibilities this framework brings.

### 2.1 Enhanced Workspace for Multimedia Processing Researchers

This version of the Knowledge Machine is intended to support the activities of researchers, who may be developing new algorithms for analysis of audio or symbolic representations of music, or may wish to apply methodically a battery of such algorithms to a collection or multiple sub-collections of music. For example, we may wish to examine the performance of a number key finding algorithms on a varied collection, grouping the pieces of music along multiple dimensions by, say, instrumentation, genre, and date of composition. The knowledge representation should support the definition of this experiment in a succinct way, selecting the pieces according to given criteria, applying each algorithm, perhaps multiple times in order to explore the algorithms' parameter spaces, adding the results to the knowledge base, evaluating the performance by comparing the estimated keys with the annotated keys, and aggregating the performance measures by instrumentation, genre and date of composition. The outputs of each algorithm should be added to the knowledge base in such a way that each piece of data generated is unambiguously associated with the function that created it and all the parameters that were used, so that the resulting knowledge base is fully self-describing. Finally, a statistical analysis could be performed to judge whether or not a particular algorithm has successfully captured the concept of ‘key’, and if so, to add this to the ontology of the system so that the algorithm gains a semantic value; subsequent queries involving the concept of ‘key’ would then be able to invoke that algorithm even if no key annotations are present in the knowledge base.

### 2.2 Semantic Web Service Access to Knowledge Machines

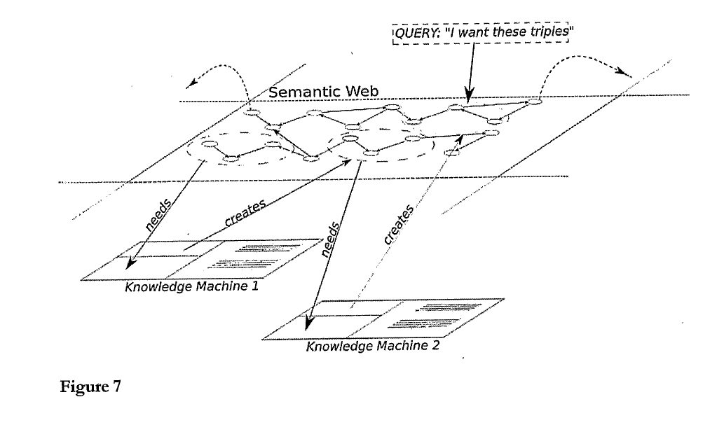

FIG. 7 illustrates a situation where more than one Knowledge Machine interacts through a Semantic Web layer, acting as a shared information layer. Once the shared information layer holds a substantial amount of knowledge, it can be useful for entities external to the Knowledge Machine framework. For example, a feature visualiser (such as Sonic Visualiser, which is available from the Centre for Digital Music at Queen Mary, University of London or via the popular Open Source software repository, SourceForge) would send a simple query to compute (or retrieve) some features, such as a segmentation of a song, for displaying on a user's local terminal.

Equally, in order to satisfy a particular query, a Knowledge Machine can access predicates that other researchers working on other knowledge machines have developed.

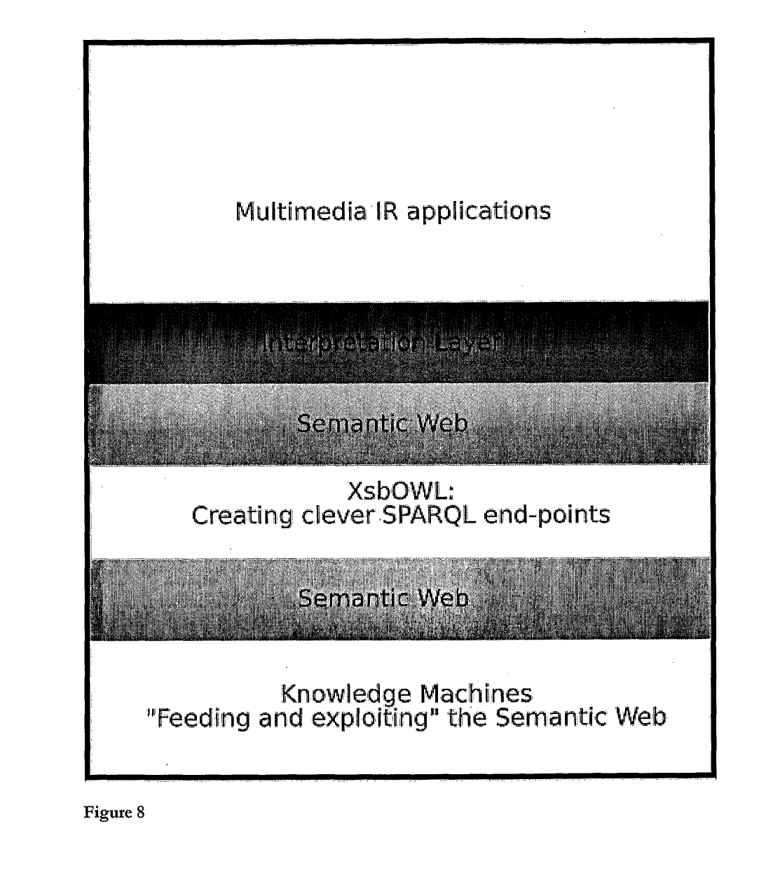

Moreover, as shown in FIG. 8, multimedia information retrieval applications can be built on top of this shared environment, through a layer interpreting the available knowledge. For example, if a Knowledge Machine is able to model the textural information of a musical audio file, and if there is an interpretation layer which is able to compute an appropriate distance between two of these models, an application of similarity search can easily be built on top of all of this. We can also imagine more complex information access systems, where a lot of features computed by different Knowledge Machines can be combined with social networking data, which is part of the shared information layer too.

### 2.3 Consumer Music Collection Processing and Navigation

Consumers today are likely to own several thousand digital music tracks, for example on a personal device like an iPod. A Knowledge Machine, for example running on the consumer's PC, simplifies the task of searching within this type of collection. Either many thousand computations (e.g. to calculate timbral similarity metadata for each song) are straightforwardly initiated by a simple query, or more commonly, the query is satisfied by searching precomputed metadata.

It is unlikely that the personal device will do the sorts of massive computation to calculate the metadata, but they will use the metadata (which will be downloaded along with the song itself) in presenting users with new and simpler ways to navigate and enjoy their music collections.

### 2.4 Professional Music Production

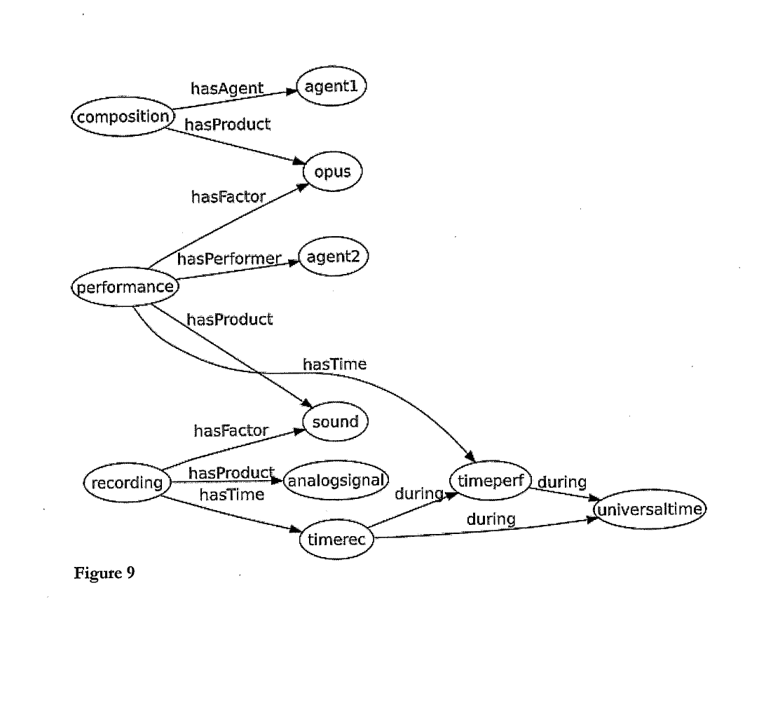

Music recording studios generally deal with a large number of small audio tracks, mixed together to create a single musical piece. The semantic work-space that a Knowledge Machine provides will not only enable recording engineers and musicians to be more productive, it can automatically calculate semantic metadata associated with that music, not only for each separate instrument, but also for the composite, mixed work. Part of the ontology relevant to such a situation is shown in FIG. 9.

### 2.5 A Format Conversion Knowledge Machine

A Knowledge Machine can be used for converting raw audio data between formats. Several predicates are exported, dealing with sample rate or bit rate conversion, and encoding. This is really useful, as it might be used to create test sets in one particular format, or even to test the robustness of a particular algorithm to information loss.

In the following example we use the language SPARQL which is a SQL-like language adapted to the specific statement structure of an RDF model. This fragment retrieves audio files which corresponds to a track named “Psycho” and which encodes a signal with a sampling rate of 44100 Hz.

SELECT ?t WHERE {
?t rdf:type mo:AudioFile.
?t mo:musicBrainzTrack ?mb.
?mb rdf:type mb:Track.
?mb dc:title “Psycho”.
?t mo:encodes ?s.
?s mo:sampleRate “44100”\hat{ }\hat{ }xsd:int
}
Note that:
rdf: is the main RDF namespace,
mo: is our ontology namespace,
mb: is the MusicBrainz's namespace,
dc: is the Dublin Core namespace.

### 2.6 A Segmentation Knowledge Machine

This Knowledge Machine is able to deal with segmentation from audio, as described in greater details in [AbRaiSan2006] the contents of which are incorporated by reference. It exports just one predicate, able to split the time interval corresponding to a particular raw signal into several smaller time intervals, corresponding to a machine-generated segmentation. A knowledge emachine can be used to keep track of hundreds of segmentations, enabling a thorough exploration of the parameter space, and resulting in a database of over 30,000 tabled function evaluations.

### 3. Key Components of a Knowledge Machine

### 3.1 Computation Engine

The computation-management facet of the Knowledge Machines is handled through calls to an external evaluation engine, which can be of any type (Matlab, Lisp, C++, etc.). These calls are handled in the language of predicate calculus, through a binary unification predicate (such as the ‘is’ predicate in standard Prolog, allowing unification of certain terms).

For example, if we define the operator === as evaluating terms representing Matlab expressions, we can define (in terms of predicate calculus) a matrix multiplication as mtimes(A,B,C) if C===A*B. We can now build composite formulæ involving the predicate mtimes and the logical connectors defined previously.

### 3.2 Function Tabling

To keep track of computed data, we consider tabling of such logical predicates. Since every predicate can be seen as a relation, a computational system built from a network of functions automatically defines a relational schema which can be used to store the results of each computation—it amounts to tabling or memorising each function evaluation. The data can then be retrieved using a query which closely parallels the expression used to compute that data in the first place. Essentially, we treat each function like a ‘virtual table’, any row of which can be computed on demand given a value in the domain of the function (which may be a tuple corresponding to several columns). However, we can also arrange that each time a row is computed in this way, it is stored as a row in an actual table. These tabled rows can be subsequently be enumerated and provide a record of previous computations. Our approach is similar in spirit to the tabling implemented in the XSB Prolog system, but we only allow tabling of predicates which correspond to functions.

To support the kind of analysis and experimentation we are interested in also requires that the library of available computations be represented at some level of granularity. Each computation would be annotated with information about the types of its arguments and returned results, its implementation language (so that it can be invoked automatically), whether it behaves as a ‘pure’ function (deterministic and stateless) or as a stochastic computation, which is useful for Monte Carlo-based algorithms, and whether or not the computation should be ‘tabled’ or ‘memorized’, as described below.

In the current implementation of our system, whenever a computation marked for tabling is performed, the system makes a record of the computation event, storing the inputs and outputs, the time and duration of the computation, and the name of the computer used. For pure functions, these computation records eliminate repeated evaluation of the same function with the same arguments, so, for example, if many algorithms use an audio spectrogram as an intermediate processing step, the spectrogram is computed just once the first time it is required.

With these elements in place, various procedures can be put in place to reason about the contents of the knowledge base and expand it in a structured way. For example, we can combine a function with its table of previous evaluations to create a sort of ‘virtual relation’ or ‘view’, which can answer queries by looking up previous evaluations or, if all the inputs to the function are supplied, by triggering new evaluations. This means that the results of a computation can be retrieved using the same query that triggered the computation the first time round.

Alternatively, if a function is very cheap to compute, we may choose not to table it, in which case it can only take part in queries where all its inputs are supplied.

Once a function has been ‘installed’ into the ontology as a relation with the same logical status as other predefined relations, it may be given semantic value, for example, by stating that it is equivalent to or a sub-property of some existing property like ‘key’ or ‘tempo’. This would enable it to take part in general reasoning tasks such as user level queries or experiment design.

For example, if we declare the predicate mtimes (as above) to be tabled, and we have two matrices a and b, the first time mtimes(a,b,C) is queried the Matlab engine will be called. Once the computation done, and the queried predicate has successfully been unified with mtimes(a,b,c), where c is actually a term representing the product of a and b, the corresponding tuple will be stored. When the query mtimes(a,b,C) is repeated, the computation will not be done, but the stored result will be returned instead.

### 3.3 Knowledge Machines in a Semantic Web Knowledge Environment

In this section, we describe how we provide a shared, scalable, distributed knowledge environment, using Semantic Web technologies. We will also explain how Knowledge Machines can interact with this environment, and so be able to publish new facts and assertions, retrieve facts and data or by providing or accessing resources for processing.

We may also want to dynamically introduce new domains in the knowledge environment (such as social networking data, or description of newly acquired multimedia raw resources concerning zoology).

We will refer to several specifications that are part of the Semantic Web effort. These are: RDF (Resource Description Framework) used to define how to describe resources, and how to link them, using triples (sets of {Subject, Predicate, Object}). An ontology written in OWL (Ontology Web Language) is able to express knowledge about one particular domain, in RDF. SPARQL (Simple Protocol And RDF query language) defines a way to query RDF data. Finally, a SPARQL end-point is a web access point to a set of RDF statements.

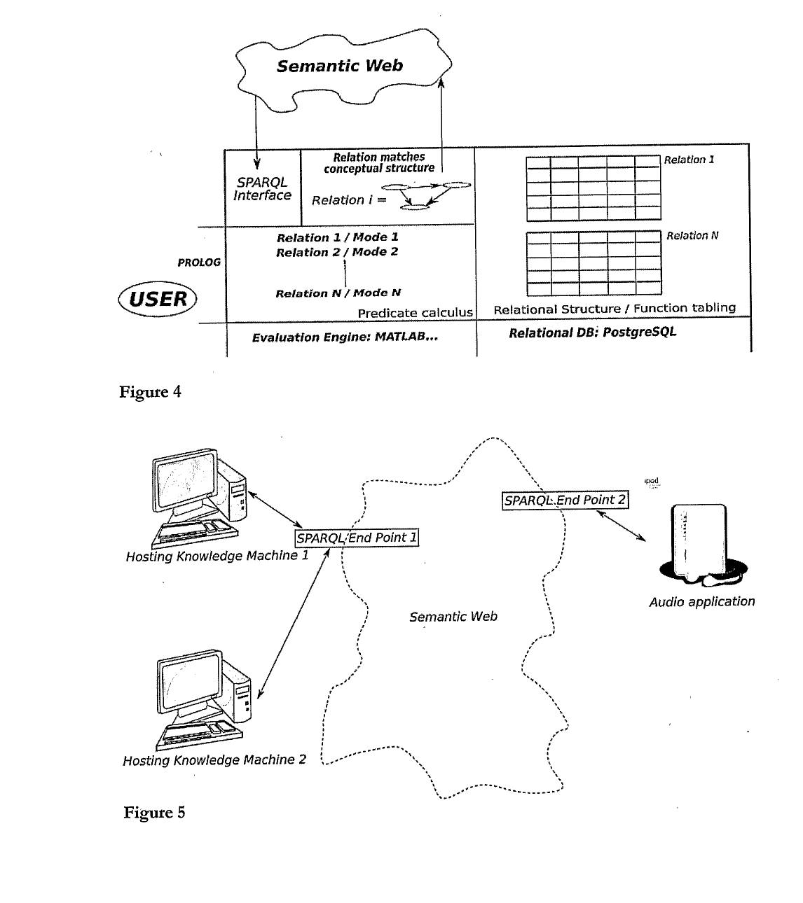

Each Knowledge Machine includes a component specifically able to make it usable remotely. This can be a simple Servlet, able to handle remote queries to local predicates, through simple HTTP GET requests. Alternatively the SOAP protocol for exchanging XML messages might be used. This is particularly useful when other components of the framework have a global view of the system and need to dynamically organise a set of Knowledge Machines. Refer to FIG. 4 for one possible Knowledge Machine structure, and to FIG. 7 to see how Knowledge Machines can interact on a task.

There are several ways to make RDF information accessible, over the web or otherwise. One option is to create a central repository, referring either to RDF files or SPARQL end-points (possibly backed by a database). Another option is to use a peer-to-peer Semantic Web solution, which allows a local RDF knowledge base to constantly grow, updating it using the knowledge base of other peers.

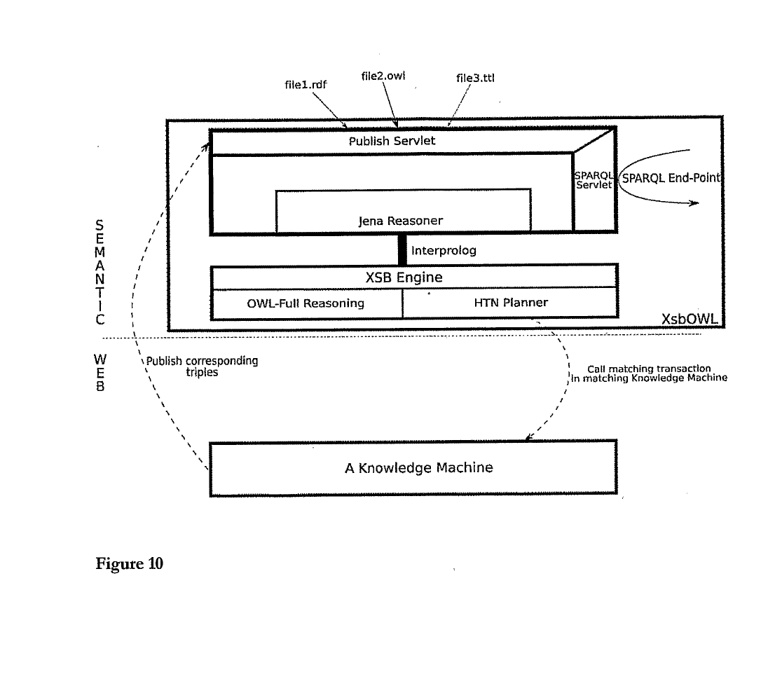

To make Semantic Web data available to Knowledge Machines and other entities wanting to make queries, we designed a program that creates SPARQL end-points, called XsbOWL (see FIG. 10). It allows SPARQL queries to be done through a simple HTTP GET request, on a set of RDF data. Moreover, new data can be added dynamically to the Semantic Web, using a HTTP GET request.

To handle reasoning on the underlying Semantic Web data, the system uses an XSB Prolog engine. This is able to provide reasoning on ontology data in OWL, and can also dynamically load new Prolog files specifying other kinds of reasoning, related to specific ontologies. For example, we could integrate in this engine some reasoning about temporal information, related to an ontology of time.

We developed an ontology of semantic matching between a particular predicate and a conceptual graph, which is similar to a subset of OWL-S [McGuinHarmelen, 2003] (with a fixed grounding, and variables which might be instanciated by a query—for example, the query ‘give me this file at this sample rate’ might instanciate a variable corresponding to the sample rate). This ontology is able to express things like ‘by calling this predicate in this knowledge machine, these RDF triples will be created’.

Including a planner in XsbOWL, enables full use of the information encapsulated in the ontology of semantic matching. Its purpose is to plan which predicate to call in which Knowledge Machine in order to teach a state of the world (which is the same as the set of all RDF statements known by the end-point) which will give at least one answer to the query (see FIG. 7). For example, if there is a Knowledge Machine somewhere which defines a predicate able to locate all the video segments corresponding to a penalty in a football match, querying the end-point for a sequence showing a penalty during a particular match should automatically use this predicate.

### 3.4 Ontologies

In order to make the knowledge environment understandable by Knowledge Machines and other entities, it is designed according to a shared understanding of the specific domain we want to work on. An ontology provides this common way of expressing statements in a particular domain. Moreover, the expressiveness of the different ontologies specifying this environment will implicitly state how dynamic the overall framework can be. The ontological structure is a really good way to manage a multidimensional information space because the user is relieved from inventing naming schemes to give meaning to data.

### 3.4.1 Important Ontology Concepts

In this section, we list some of the important concepts to be represented in a music information ontology. Since we have already implemented a prototype system, some of the text below is phrased as a description of our current system, but these also stand as requirements or recommendations for a common multimedia ontology.

A review of the literature on ontology development highlighted a number of points to consider when designing an ontology. These include modularity [Rector2003] and ontological ‘hygiene’ as addressed by OntoClean methodology [WeltyGuarino2001]. In addition, we have adopted or made reference to some of the ontological structures to be found in previous ontology projects, including MusicBrainz [Swartz02], SUMO [PeaseEtAl2002], and the ABC/Harmony project [LagozeHunter2001], though none of these was deemed suitable as a direct base for our system, being either too general or too specific.

Given that we wish to represent information about music and music analysis, our ontology must cover a wide range of concepts, including non-physical entities such as Mahlers's Second Symphony, human agents like composers and performers, physical events such as particular performances, occurrent sounds and recordings, and informational objects like digital signals, the functions that analyse them and the derived data produced by the analyses.

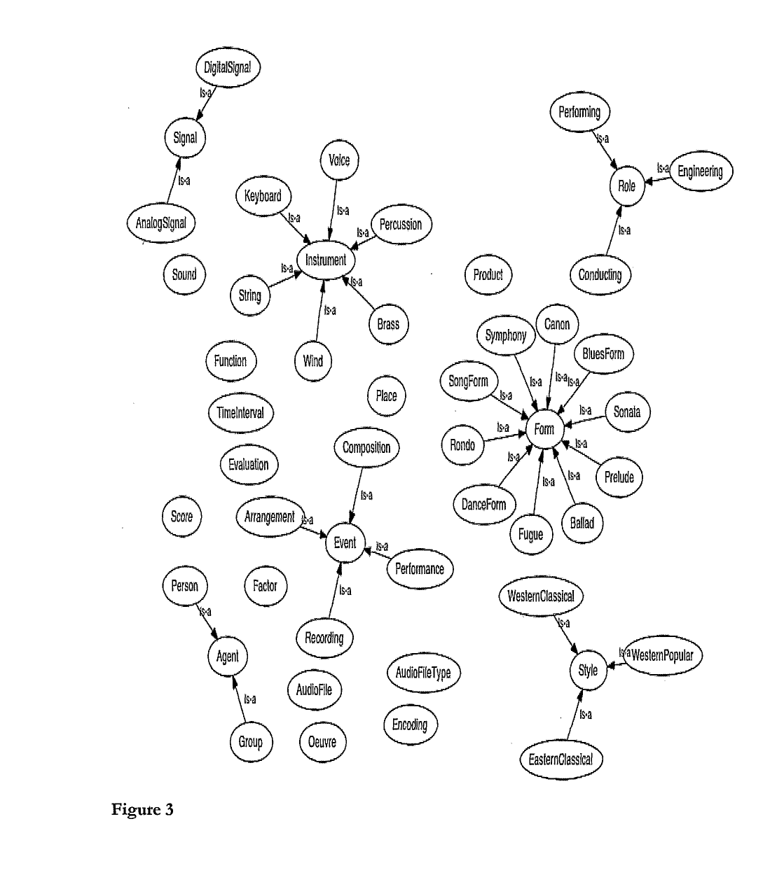

The three main areas covered by the ontology are (a) the physical events surrounding an audio recording, (b) the time-based signals in a collection and (c) the algorithms available to analyse those signals. Some of the top-level classes in our system are illustrated in FIG. 3 and described in greater detail below.

Music is above all a time-based phenomenon. We would like to see the temporal logic at heart of this, formalised in a set of concepts which will be useful for describing any temporal phenomenon, such as video sequences. Many relevant ideas have been discussed in the AI, logic and knowledge representation literature [Allen84, Galton87]. In particular, the idea of multiple timelines, both continuous and discrete, is relevant for signal processing systems where multiple continuous-time and discrete-time signals may co-exist, some of which will be related (conceptually co-temporal) and some of which will be unrelated. Each timeline can support its own universe of time points, intervals and signals. However, timelines of different topologies can be related by maps which accurately capture the relationship implied when, for example, a continuous timelines is sampled to create a discrete timeline, or when a discrete timeline is sub-sampled or buffered to obtain a new discrete timelines.

Closely related to temporal logic is the representation of events, as addressed in the literature on event calculi [KowalskiSergot86, Galton91, VilaReichgelt96]. The ontology of events has also been addressed in the semantic web literature [LagozeHunter2001, PeaseEtAl2002]. In a music information system, the notion of ‘an event’ is a useful way to characterise the physical processes associated with a musical entity, such as a composition, a performance, or a recording. Extra information like time, location, human agency, instruments used and so on can be associated with the event in an extensible way.

Music is also a social activity, so the representation of people and groups of people is required, as implied above in the requirement to represent the agents involved in the occurrence of an event.

The ontology of computation requires the notion of a ‘callable computation’, which may be a pure function, or something more general, such as a computation which behaves non-deterministically. By encoding the types of all the inputs and outputs of a computation, we gain the ability to reason about legal compositions of functions. In addition, to manage the results of computations, we need a concept of ‘evaluation’ to represent computation events, recording inputs, outputs, and other potentially useful statistics like computation time.

The computation ontology we are currently developing includes a concept of ‘mode’ inspired by the Mercury language. This allows relations to be declared as strictly functional when particular attributes are treated as ‘inputs’. For example, the relation square(x,y), where, is functional when treated as a map from x to y, but not when treated as a map from y to x, since a real numbers has two square roots. Representing this information in the computation ontology will allow us to reason about legal ways to use the relation and how to optimise its use by tabling previous computations.

We aim to extend the mode system to allow for a class of stochastic computations, where the outputs is defined by a conditional probability distribution, that is p(outputs|inputs). This will be useful for representing algorithms that rely in an essential way on random number generation.

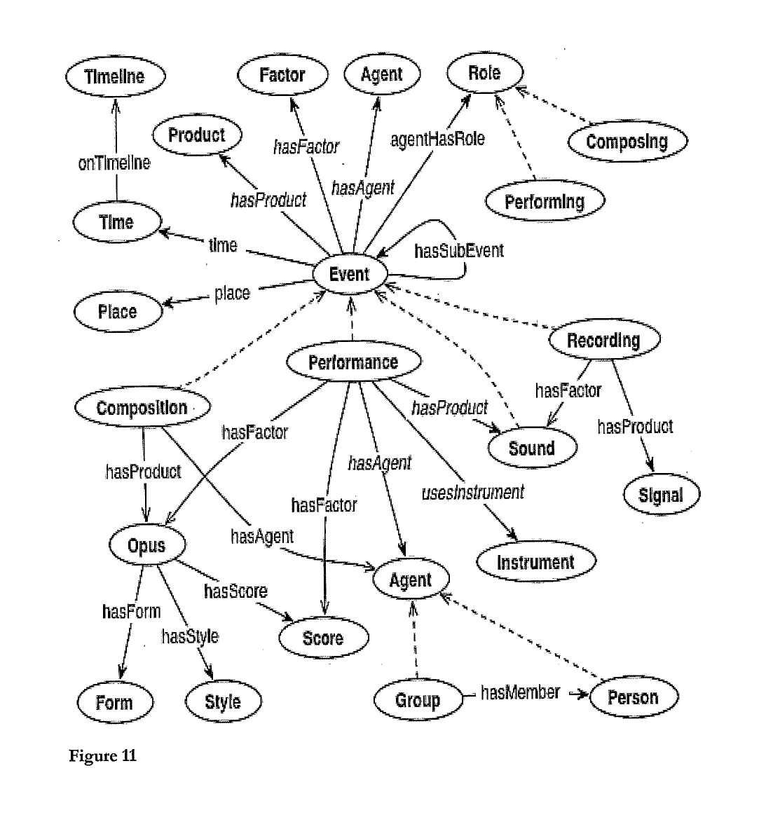

Specifically musical concepts include specialisations of concepts mentioned above, such as specifically musical events (compositions, performances), specifically musical groups of people (like orchestras or bands), specifically musical conceptions of time (as in ‘metrical’ or ‘score’ time, perhaps measured in bars (also known as measures), beats and subdivisions thereof), and specifically musical instruments. To these we must add abstract musical domains like pitch, harmony, key, musical form and musical genre. As an example, FIG. 11 presents the top-level classes in a relevant ontology.

### 3.4.2 Musical Manifestations

A musical entity can be represented in several ways. Our ontology currently includes:
Opus: this concept represents an abstract musical entity and supports every musical manifestation;
Score: this deals with symbolic representations of music, on paper, as a MusicXML digital score, or as MIDI;
Sound: this deals with the physical sound spatio-temporal field associated with a physical event;
Signal: this deals with functions mapping time to numeric values. It has two sub-classes: Analog Signal (continuous time signal) and Digital Signal (discrete time signal);
AudioFile: This deals with containers for digital signals. Instances of this class have properties describing encoding, file types, and so on.

Some of these musical manifestations (Opus, Sound, and Signal) can be sub-divided, in order to represent different movements of a symphony, different parts in a song, etc. This temporal splitting is different for each of these concepts. In the case of Opus there is no precise quantitative time structure associated with it, though it can be divided using a qualitative part-whole relation, in terms of sub-opuses. Sub-divisions of Sound and Signal are provided by the time-based signal ontology.

### 3.4.3 Qualities of Music

These describe the attributes of music applicable to various musical manifestations, either in whole or in part. They include:
Style: this class is associated with a classification of different music styles (eg. electro, jazz, punk);
Form: dealing with the musical form (eg. twelve bar/measure blues, sonata form);
Key: represented as a (tonic, mode) pair.
Tempo: dealing with the tempo structure of the musical piece;
Metre: time signature of the piece.

### 3.4.4 Agents

This is another top-level class in the ontology referring to active entities that are able to do things (particularly initiating events). It has a privileged link to the concept of event (see below). There are two subclasses:
Person, referring to unique persons,
Group, made up of agents (any agent can be part of the group).

Most of the time an agent will be associated with a role. Typically a role is a collection of actions by an agent. For example, a composer is a Person who has composed an Opus, an arranger is a Person who has arranged a musical piece. This concept of agents can be extended to deal with artificial agents (such as computer programs or robots).

### 3.4.5 Instruments

This class is a major passive factor of performance events. The classification of instruments is organized in six main sub-classes (Wind, String, Keyboard, Brass, Percussion, Voice). Multiple inheritance, for instance a piano is both a String instrument and a Keyboard instrument, is captured. Although not currently implemented, this ontology could be extended with physical concepts and properties like vibrating elements, excitation mechanisms, stiffness, elasticity.

### 3.4.6 Events

Music production usually involves physical events, which occur at a certain place and time and which can involve the participation of a number of physical objects both animate and inanimate. The following are 4 examples:
Composition: the event in which someone produces an opus (abstract musical piece)
Arrangement: the event in which someone takes an opus to arrange it and produces a score
Performance: the event in which an opus is played, implying performers and a group of people, producing a physical sound;
Recording: the event in which a physical sound is recorded, implying microphones and their locations, a sound engineer, and so on.

Because of the richness of the physical world, there can be a large amount of information associated with any given event, and finding a way to represent this flexibly within a formal logic has been the subject of much research [McCarthyHayes69, Allen84, KowalskiSergot86, Galton87, Shanahan99].

More recently, the so-called token reification [Galton91, VilaReichgelt96] approach has emerged as a consensus, where a first-class object or ‘token’ is used to represent each individual event occurrence, and a collection of predicates is used to relate each token with information pertaining to that event

Note that the subsequent acquisition of more detailed information, such as the precise date or location, does not require a redesign of the predicates used thus far and does not invalidate any previous statements.

Regarding the ontological status of event tokens, we largely adopt the view expressed by Allen and Ferguson [AllenFerguson94]:
[ . . . ] that events are primarily linguistic or cognitive in nature. That is, the world does not really contain events. Rather, events are the way by which agents classify certain useful and relevant patterns of change.

We might also expand the last sentence to say that events are the way by which cognitive agents classify arbitrary regions of space-time. Hence, the event token represents what is essentially an act of classification. This definition is broad enough to include physical objects, dynamic processes (rain), sounds (an acoustic field defined over some space-time region), and even transduction and recording to produce a digital signal. It is also broad enough to include ‘acts of classification’ by artificial cognitive agents, such as the computational model of song segmentation discussed in Use Cases. A depiction of typical events involved in a recording process is illustrated in FIG. 9.

The event representation we have adopted is based on the token-reification approach, with the addition of sub-events to represent information about complex events in a structured and non-ambiguous way. A complex event, perhaps involving many agents and instruments, can be broken into simpler sub-events, each of which can carry part of the information pertaining to the complex whole. For example, a group performance can be described in more detail by considering a number of parallel sub-events, each of which represents the participation of one performer using one musical instrument (see classes for some of the relevant classes and properties).

Each event can be associated with a time-point or a time interval, which can either be given explicitly, as in ‘the year 1963 ’, or by specifying its temporal relationship with other intervals, as in ‘during 1963 ’. Relationships between intervals can be specified using the thirteen Allen [Allen84] relations: before, during, overlaps, meets, starts, finishes, their inverses, and equals. These relations can be applied to any objects which are temporally structured, whether this be in physical time or in some abstract temporal space, such as segments of a musical score, where times may not be defined in seconds as such, but in ‘score time’ specified in bars/measures and beats.

### 3.4.7 Time-Based Signals

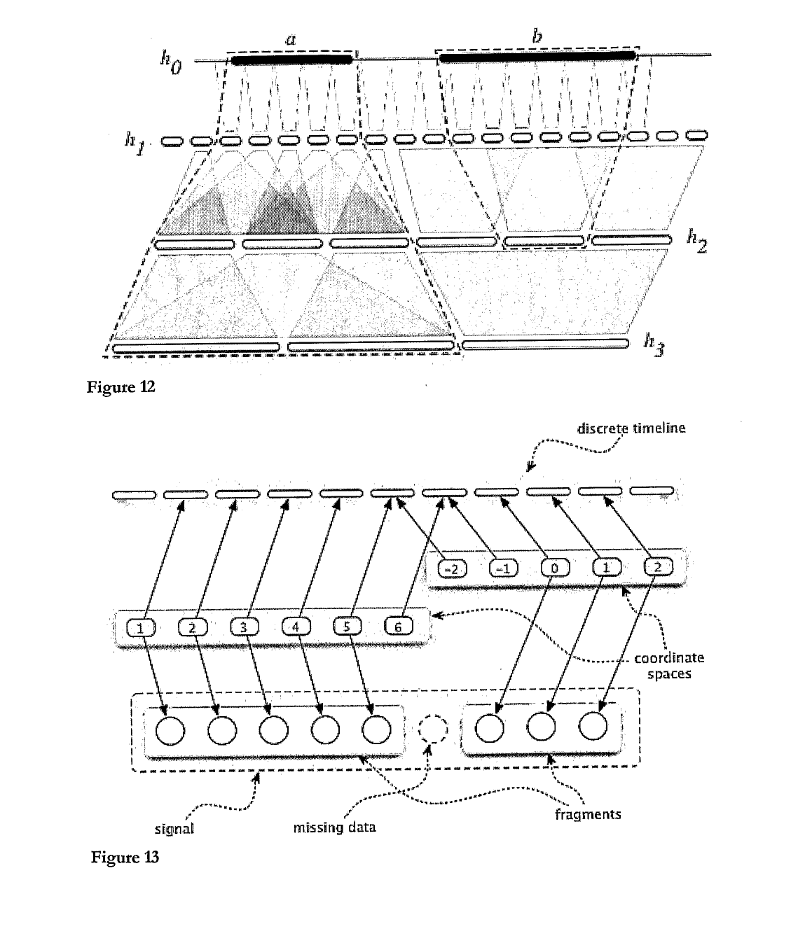

A fundamental component of the data model is the ability to represent unambiguously the temporal relationships between the collection of signal fragments referenced in the database—see FIG. 12. This includes not only the audio signals, but also all the derived signals obtained by analysing the audio, such as spectrograms, estimates of short-term energy or fundamental frequency, and so on. It also includes the temporal aspects of the event ontology discussed above: we may want to state the relationship between the time interval occupied by a given event and the interval covered by a recorded signal or any signal derived from it. The representation of a signal simply as an array of values is not sufficient to make these relationships explicit, and would not support the sort automated reasoning we wish to do.

The solution we have adopted is in a large part a synthesis of previous work on temporal logics [Allen84, Hayes95, Vila94], which attempt to construct an axiomatic theory of time within the framework of a formal logic. This involves introducing several new types of object into our domain of discourse. Multiple timelines, which may be continuous or discrete, represent linear pieces of time underlying the different unrelated events and signals within the system. Each timeline provides a ‘backbone’ which supports the definition of multiple related signals. Time coordinate systems provide a way to address time-points numerically. The relationship between pairs of timelines, such as the one between the continuous physical time of an audio signal and the discrete time of its digital representation, is captured using timeline maps—see FIG. 12 for an example.

A particular signal is then defined in relation to a particular timeline using one or more coordinate systems to attach the signal data to particular time-points—FIG. 13 shows an example of a (rather short) signal defined in two fragments (which could be functions or Matlab arrays); these are attached to a discrete timeline via two integer coordinate systems.

Signals may be stored in any format, including any sampling rate (e.g 44100 Hz, 96000 Hz), bit depth (e.g. 16 or 24 bits), compression (e.g. MP3, WAV) and bit-rate (e.g. 64 kbs, 192 kbs) and so on. They can be monaural, stereophonic, multi-channel or multi-track.

### 3.4.8 Extensibility of the Ontology

We do not claim to have achieved complete expressiveness for music production knowledge, in the sense that we have not included every concept that might be useful in a situation. There are specific classes, however, which are intended to be specialisable (by subclassing) in order to be able to describe specific circumstances. For example, any instrument taxonomy can be attached below the root instrument class, or any taxonomy of musical genre could be placed under the root genre concept. Similarly, new event classes could be defined to describe, for example, novel production processes.

The representation of physical events has also been addressed in other ontologies, notably ABC [LagozeHunter2001], and SUMO [PeaseEtAl2002]. These may be useful when designing multimedia ontologies, especially where they help to identify which concepts are so general that they transcend particular domains like music, multimedia, computation etc. In addition, we found the OntoClean methodology and meta-ontology [WeltyGuarino2001] provided some valuable insights when trying to clarify the role of each concept in an ontology.

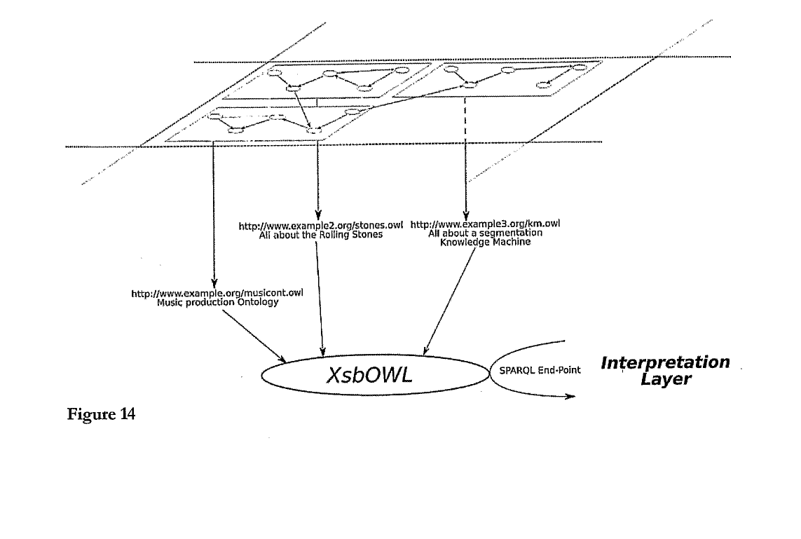

Using the modularisation of domain ontologies defined in [Rector2003], we can draw clear links between the different domains of our ontology, but also between one of our domain and another ontology. In our current system, we have such explicit links to two ontologies. The first one is the MusicBrainz ontology. MusicBrainz is a semantic web service [Swartz02], describing CDDB-style information, such as artists, songs and albums. The second one is the Dublin Core ontology. It handles some common general properties like ‘title’, ‘creator’. FIG. 14 presents an example where several ontologies, external to a Knowledge Machine are brought into play on a single task.

### 3.5 Closing the Semantic Gap

Having expressed both circumstantially related information—which may have some ‘high level’ or ‘semantic’ value—and derived information in the same language, that of predicate logic, we are in a good position to make inferences from one to the other; that is, we are well placed to ‘close the semantic gap’. For example, the score of a piece of music might be stored in the database along with a performance of that piece; if we then design an algorithm to transcribe the melody from the audio signal associated with the performance, the results of that computation are on the same semantic footing as the known score. A generalised concept of ‘score’ can then be defined that includes both explicitly associated scores (the circumstantially related information) and automatically computed scores. Querying the system for these generalised scores of the piece would then retrieve both types.

### 4 Implementation

In one implementation, the ontology is coded in the description logic language OWL-DL. The different components of the system, on the Semantic Web side, are integrated using Jena, an open source library for Semantic Web applications. We store relational data models using an RDBMS accessed via SQL managed by Jena. The database is made available as a web service, taking queries in SPARQL (a SQL-like query language for RDF triples). Knowledge Machines, based on SWI-Prolog have been implemented to allow standard Prolog-style queries to be made using predicates with unbound variables and returning matches one-by-one on backtracking. This style is expressive enough to handle very general queries and logical inferences. It also allows tight integration with the computational facet of the system, built around a Prolog/Matlab interface.

Matlab is used as an external engine to evaluate Prolog terms representing Matlab expressions. The service is provided through the binary predicate === much as standard Prolog allows certain terms to be evaluated using the ‘is’ binary predicate. Matlab objects can be made persistent using a mechanism whereby the object is written to a .mat file with a machine-generated name and subsequently referred to using a locator term. These locator terms can then be stored in the database, rather than storing the array itself as a binary object.

Other computational engines can be integrated in this system, such as Octave, LISP, Java C/C++ compiled code, as can specialist hardware, such as DSP processors, graphics cards, etc.

In another implementation, a Knowledge Machine can be constructed from the following components:
Axis: a library managing the upper web-service side, SOAP communication, and available objects for remote calls;
Struts: a library managing the dynamic web-application side, through Java Server Pages bound with actions and forms. It allows access to a dynamically generated RDF model, writing a serialization of it as RDF/XML to a dynamic web page. This way it can be browsed using a RDF browser, such as Haystack
Jena: is a Java Semantic Web library, from Hewlett Packard. It wraps the core RDF model, and gives access to it by a set of Java classes;
Prolog (server-side): A prolog RDF model, mirror of the Jena RDF model, used to do reasoning;
Racer: is a Description Logic reasoner. It directly communicates with Jena using the DIG (DL Implementors Group) interface. This reasoner is accessible by querying the Jena model using SPARQL;
Tomcat: is the web application server, part of the Jakarta project;
Java core client: Designed using WSDL, it wraps the two-layer SOAP interface to accessible remote objects;
Java file client: Wraps the core client, designed to easily handle remote population of the database, particularly for audio;
Prolog client: Wraps the core client, in order to access parts of the main RDF model, identified by a SPARL query, and use it in a predicate calculus/function tabling context;
Matlab client: A small wrapper of the core client for Matlab, enabling direct access to audio files described in the main RDF model through SPARQL queries.

### APPENDIX III

### Business Model

The Digital Music market is booming and new applications for better enjoyment of digital music are increasingly popular. These include systems to navigate personal collections (e.g. producing play lists), to enjoy existing music better (e.g. automatic download of lyrics to a media player) and to get recommendations for new listening and buying experiences. Metadata—information about content—is the key to these applications. It is a sophisticated form of tagging.

Today, the metadata used to provide these experiences are manually annotated (e.g. the CDDB database of song/CD titles your music player on your PC interrogates) and are largely un-related to the sound of the music. This makes it difficult to meet users' expectations of advanced music delivery systems, without reliable information on likes and dislikes.

There are other problems with manual metadata. Firstly, it is error-prone and not necessarily consistent. Secondly, the human annotators must be highly skilled, and thirdly it is time consuming and therefore expensive. The present invention is being commercialised by an entity called Isophonics. Isophonics' view is that we are currently in the early days of computer assisted music consumption. We see it evolving in at least 2 more generations beyond today's manually tagged, 0th generation. The first generation will use simple automatic tagging, based on proprietary metadata formats. The second generation will be based around'a largely standardized metadata format that incorporates more sophisticated tagging and hence more sophisticated music seeking capabilities. Isophonics will provide services and tools for the consumer for creating and using metadata (1^{st} generation), and then 2nd generation tools and services for content owners, who will generate high-quality, multi-faceted tagging.

Typical 1st generation products will perform both analysis/description of the music and management of metadata tags. By giving away its 1st generation tools (home-taggers), consumers get the means to work with and enjoy their own collection, search for likely new discoveries by sharing tags over a peer-to-peer network or Isophonics' site, while Isophonics builds a massive on-line library of Isophonics' Music Metadata (IMM) tags. Isophonics profits from referrals to music sales, while consumers can optionally buy an upgraded home- (or pro-)tagger.

Consumers will find the first generation an improvement on manual tagging, but still not meeting their aspirations. An important drawback is that products from different companies will not be compatible. Users will need inter-operability across all music services and will generate demand for standardised, sharable, inter-operable metadata. This is where Isophonics' 2nd generation strategy comes into play.

Second generation consumer offerings will enable them to enjoy music in totally new ways while enhancing the work flow of music professionals in the studio, and collecting Isophonics' Gold Standard Music Metadata (IGSMM) at the point of content creation. The standardised, high-detail, metadata of the second generation tools, systems and services will help the music content owners (labels) to create and manage inter-operable IGSMM, which will be robustly copy-protected. Crucially, the labels will buy into using Isophonics' system because it improves their offering to consumers, and discourages consumers from illegal download which wouldn't have the intelligent tagging, and therefore wouldn't be nearly so compelling. By building brand and reputation, through 1st generation offerings and simultaneously developing the 2nd generation, Isophonics will be well placed to capitalize, particularly as increasing proportions of Digital Music are sold shrink-wrapped together with IGSMM.

### Benefits to Potential Users

Users fall into 2 categories: consumer and profession. For the first generation, the main target market are home consumers. With intelligent, semantic tagging, they will find many new and compelling ways to enjoy their music. They can easily build intelligent playlists—for jogging, driving, relaxing and smooching—discover and purchase new music from web sites that recognise their metadata, and, for an important minority, learn about the way songs and symphonies are structured and composed. They can also share these tags with friends over a peer-to-peer network, discovering shared musical tastes. Music stores will sell more music by making better recommendations.

With the second generation, more of the profession side opens up, and content owners will offer music enhanced (at the point of sale) with the IGSMM tags. The extra fun and functionality that listeners gain will mean they will be less inclined to illegally download music and more inclined to obtain legitimate copies. IGSMM will enable consumers to browse all their friends' collections or vast on-line music stores, regardless whether they are using Windows Media Player or iTunes. They will be able to view chord sequences played by the guitarist, and skip to the chorus etc. They will be able to find music with very precise matching requirements (e.g. I want something with a synthesiser sound like the one Stevie Wonder uses), or with highly subjective requirements like mood and emotion. Recording engineers will find that the extra functionality offered by IGSMM tagged music makes their work more straightforward. They will not be aware of collecting metadata, and will not need special expertise to manage it.

### Target Market and Potential Size

The food chain starts at the point of creation of music—the recording studio—and ends with the consumer, touching many other players on the way, including Recording Studios, Application Service Providers, Internet and 3G Service Providers, Music Stores.

Hence the commercial potential of this business is substantial. UK consumers alone spend more than £1 Billion on recorded music every year, with an ever-increasing proportion delivered over the internet. The world market in 2003 was about £30 Billion. Markets in India (with its thriving movie industry) and China are set to grow dramatically. Phone handsets increasingly need ways to manage stored music, and with about 500 million handsets sold each year, there is vast potential here for licensing.

On the professional side, the market also offers opportunities. There are believed to be about 500,000 installed copies of professional and semi-professional audio editing software products from various manufacturers, many of which can be extended with 3rd party plug-ins. Isophonics product offerings in this sector will facilitate the transition from 1st to 2nd generation markets. Subsequently Isophonics will penetrate the studio business—for tagging at the point of content creation—though this market size has not yet been estimated.

Isophonics combines peer-to-peer with music search, in a scalable way, incorporating a centralized reliable music service provider, and without any direct responsibility to deliver, or coordinate the Rights Management of, the content itself. It also adds an element of fun and learning by discovery some of the hidden delights of musical enjoyment.

### Route to Market

Isophonics plan is long term, and covers the two generations discussed above. The big win comes from owning the ‘music metadata’ space in the second generation. To make that possible, Isophonics will enter the first generation market in the following way.

Isophonics' first act will be to promote SoundBite, a music search technology, to early adopters like the Music IR community and via social networks like MySpace. It will be available for download from Isophonics, typically as an add-on to a favourite music player. In the background, SoundBite tags all songs with our high-level descriptor format, Isophonics Music Metadata (IMM), much like Google Desktop Search does its indexing. But Isophonics will also collect a copy of the tags and so build an extensive database of IMM, to be able to provide its search and discovery facility. When users want to listen to something they've discovered, they are re-directed to an on-line music store, allowing them to listen, and decide to buy on-line (CD or download). Revenue for Isophonics is generated by this referral—either as click-through like Google ads, or as a small levy paid by the on-line store.

As this market develops, further revenue streams will materialize. With mobile handsets offering ever more song storage (˜3000 songs in 2006), handset manufacturers will be potential licensees. The basic home-tagger will be extended on an ongoing basis. A pro-version, appealing to the more dedicated music listeners, will generate a healthy, early revenue stream.

As well as raising early revenue, this strategy of adding value to music in an appealing way quickly disseminates the Isophonics view of Digital Music collections, promotes the brand, and provides the foundations for IGSMM and the second generation.

Isophonics will develop tools for content creators (recording studios) to produce and mix metadata as a simple adjunct to an enhanced workflow, initially by offering plug-in software for existing semi-professional audio recording and mixing software (e.g. Adobe Audition). Dedicated marketing effort will be needed to promote Isophonics' novel tools to recording engineers. Later products will include fully integrated studio and professional workstations for producing and managing large amounts of IGSMM-tagged music.

In summary, revenue will be generated in the following ways:
By selling upgrades to the home tagging tool
By click-through to established on-line music stores
By selling software plug-ins to music studio recording and editing software
By providing services, such as semantic matching of user queries against music collections to find new music
By providing professional services, for example, the massive processing of music content on behalf of music content owners
By selling asset management systems for use in recording studios, sound archives, libraries and so on
By offering licences to Mobile, Internet and other service providers to offer music search services
By licencing the use of high-quality metadata to music content owners who sell songs with accompanying metadata

### REFERENCES

[AbRaiSan, 2006] S. Abdallah, Y. Raimond, and M. Sandler, “An ontology-based approach to information management for music analysis systems,” in Audio Engineering Society Convention Paper 6770, Proceedings of 120th AES Convention, Paris, May 20-23 2006.
[Allen, 1984] Allen, J. (1984). Towards a general theory of action and time. Artificial Intelligence, 23:123-154.
[AllenFerguson94] J F. Allen & G. Ferguson. Actions and events in interval temporal logic. Journal of Logic and Computation, 4(5):531-579, October 1994
[Baader et al., 2003] Baader, F., Horrocks, I., and Sattler, U. (2003). Description logics as ontology languages for the semantic web. In Hutter, D. and Stephan, W., editors, Essays in Honor of Jörg Siekmann, Lecture Notes in Artificial Intelligence. Springer.
[Galton, 1987a] Galton, A. (1987a). The logic of occurrence. In Galton, A., editor, Temporal Logics and their Applications, chapter 5, pages 169-196. Academic Press, London.
[Galton, 1987b] Galton, A., editor (1987b). Temporal Logics and their Applications. Academic Press, London.
[Galton91] A. Galton, Reified temporal theories and how to unreify them, Proceedings IJCAI '91, 1991
[Gruber, 1994] Gruber, T. R. (1994). Towards principles for the design of ontologies used for knowledge sharing. In Guarino, N. and Poli, R., editors, Formal Ontology in Conceptual Analysis and Knowledge Representation. Kluwer Academic Publishers. Available as Technical Report KSL-93-04, Knowledge Systems Laboratory, Stanford University.
[Hayes, 1995] Hayes, P. (1995). A catalog of temporal theories. Technical Report UIUC-BI-AI-96-01, Beckmann Institute, University of Illinois.
[Hunter, 2001] Hunter, J. (2001). Adding multimedia to the semantic web: Building an mpeg-7 ontology. In SWWS, pages 261-283.
[KowalskiSergot86] R. Kowalski & M. Sergot, A logic-based calculus of events, New Generation Computing, vol. 4, pp 67-95, 1986.
[LagozeHunter, 2001] Lagoze, C. and Hunter, J. (2001). The ABC ontology and model. In Dublin Core Conference, pages 160-176.
[Low, 1999] Low, A. (1999). A folder-based graphical interface for an informational retrieval system. Master's thesis, Dept. of Electrical Engineering and Computer Science, MIT.
[McCarthy and Hayes, 1969] McCarthy, J. and Hayes, P. J. (1969). Some philosophical problems from the standpoint of artificial intelligence. In Meltzer, B. and Michie, D., editors, Machine Intelligence, volume 4, pages 463-502. Edinburgh University Press.
[McGuinHarmelen, 2003] D. L. McGuinness and F. van Harmelen, “Owl web ontology language: Overview,” World Wide Web Consortium,” Working Draft, March 2003. [Online]. Available: http://www.w3.org/TR/2003/WD-owl-features-20030331/
[Nilsson and Maluszyski, 2000] Nilsson, U. and Maluszyski, J. (2000). Logic, Programming and Prolog. Wiley and Sons, second edition.
[PeaseEtAl2002] A. Pease, I. Niles & J. Li, The suggested upper merged ontology: A large ontology for the semantic web and its applications, in Working Notes of the AAAI-2002 Workshop on Ontologies and the Semantic Web, Edmonton, Canada, 2002
[Quan et al., 2003] Quan, D., Huynh, D., and Karger, D. (2003). Haystack: A platform for authoring end user semantic web applications.
[Rector, 2003] Rector, A. L. (2003). Modularisation of domain ontologies implemented in description logics and related formalisms including owl. In Proceedings of the international conference on Knowledge capture, pages 121-128. ACM Press.
[Roinila, 2002] Roinila, M. (2002). Idea forces and causality in leibniz.
[Shanahan, 1999] Shanahan, M. P. (1999). The event calculus explained, In Woolridge, M. J. and Veloso, M., editors, Artificial Intelligence Today, Lecture Notes in AI no. 1600, pages 409-430. Springer.
[Swartz, 2002] Swartz, A. (2002). Musicbrainz: A semantic web service. IEEE Intelligent Systems, 17(1):76-77.
[Vila, 1994] Vila, L. (1994). A survey on temporal reasoning in artificial intelligence. AI Communications, 7(1):4-28.
[VilaReichgelt96] L. Vila & H. Reichgelt, The token reification approach to temporal reasoning, Artificial Intelligence, vol. 83, no. 1, pp 59-74, 1996.
[WeltyGuarino2001] C. Welty & N. Guarino, Supporting ontological analysis of taxonomic relationships, Data and Knowledge Engineering, vol. 39, pp 51-74, 2001.
[Wielemaker et al., 2003] Wielemaker, J., Schreiber, G., and Wieling a, B. (2003). Prolog-based infrastructure for rdf: Scalability and performance.

1. A method of analysing audio, music or video data, comprising the steps of:
(1) a database storing audio, music or video data;
(2) a processing unit analysing the data to automatically generate meta-data in conformance with an ontology and to infer knowledge from the data and/or the meta-data.

2. The method of claim 1 in which the processing unit stores the meta-data in the database as further data, enabling the processing unit to analyse the further data to generate meta-data.

3. The method of claim 1 in which the processing unit includes a maths processing unit and a logic processing unit.

4. The method of claim 1 in which the ontology is a collection of terms specific to the creation, production, recording, editing, delivery, consumption, processing of audio, video or music data and which provide semantic labels for the audio, music or video data and the meta-data.

5. The method of claim 1 in which the ontology includes an ontology of one or more of the following: music, time, events, signals, computation, any other ontology available on the internet or the Semantic Web.

6. The method of claim 5 in which the ontology of music includes one or more of:
(a) musical manifestations, such as opus, score, sound, signal;
(b) qualities of music, such as style, genre, form, key, tempo, metre
(c) agents, such as person, group and role, such as engineer, producer, composer, performer;
(d) instruments;
(e) events, such as composition, arrangement, performance, recording
(f) functions analysing existing data to create new data

7. The method of claim 5 in which the ontology of time includes time-point, moment, time interval, timeline, timeline mapping, co-ordinate systems.

8. The method of claim 7 in which the ontology of time uses interval based temporal logics.

9. The method of claim 5 in which the ontology of events includes event tokens representing specific events with time, place and an extensible set of other properties.

10. The method of claim 5 in which the ontology of signals includes sample, frame, signal fragment, acoustic, electronic, stereo, multi-channel, live, discrete and continuous time signals.

11. The method of claim 5 in which the ontology of computation includes Fourier transform, filtering, onset detection, hidden Markov modelling, Bayesian inference, principal and independent component analyses, Viterbi decoding, and relevant parameters, callable computation, non-deterministic function, evaluation, computational events, computation time, argument types, access modes, determinism, evaluation events.

12. The method of claim 11 in which the ontology of computation can be dynamically modified.

13. The method of claim 11 comprising the step of managing the computation by using functional tabling, in which the computations and outcomes are stored in a database, in order to contribute to future computations.

14. The method of claim 5 in which the ontology includes an ontology of semantic matching, which associates an algorithm to one or more concepts and includes some or all of the following terms: predicate, Knowledge Machine, RDF triples, match.

15. The method of claim 1 including the step of applying temporal logic to reason about the processes and results of signal processing.

16. The method of claim 15 in which internal data models represents unambiguously temporal relationships between signal fragments in the database.

17. The method of claim 15 which builds on previous work on temporal logic by adding new types or descriptions of object.

18. The method of claim 15 which allows for multiple time lines to support definition of multiple related signals.

19. The method of claim 15 in which time-line maps are generated, handled or declared.

20. The method of claim 5 in which knowledge extracted from the Semantic Web is used in the processing to assist meta-data creation.

21. The method of claim 1 in which there are several sets of databases, processing units and logical processing units.

22. The method of claim 21 in which the several sets are each on different user computers or other appropriately enabled devices.

23. The method of claim 1 in which the database is distributed across the Internet and/or Semantic Web.

24. The method of claim 1 in which there are several sets of databases, processing units and logical processing units, co-operating on a task.

25. The method of claim 1 deployed automatically in a system used for the creation of artistic content.

26. The method of claim 25 in which the system also manages various independent instrument recordings.

27. The method of claim 26 in which the system processes related metadata to provide a single or integrated metadata representation that corresponds appropriately to a combination of the instrument recordings, whether raw or processed, that constitutes the musical work.

28. The method of claim 1 in which the meta-data analysed by the processing unit includes manually generated meta-data.

29. The method of claim 1 in which the meta-data analysed by the processing unit includes pre-existing meta-data.

30. The method of claim 1 in which the ontology includes a concept of ‘mode’ that allows relations to be declared as strictly functional when particular attributes are treated as ‘inputs’ and allows reasoning about legal ways to use the relations and how to optimise its use by tabling previous computations.

31. The method of claim 30 in which the mode allows for a class of stochastic computations, where the outputs is defined by a conditional probability distribution.

32. The method of claim 1 in which information retrieval applications are built on top of a Semantic Web environment, through a layer interpreting the knowledge available in the Sematic Web.

33. A music, audio or video data file tagged with meta-data generated using the above method claim 1.

34. A method of locating music, audio or video data by searching against meta-data generated using the above method claim 1.

35. A method of purchasing music, audio or video data by locating the music, audio or video using the method of claim 34.

36. A database of music, audio, or video data tagged with meta-data generated using the above method claim 1.

37. A personal media player storing music, audio, or video data tagged with meta-data generated using the above method claim 1.

38. The personal media player of claim 36 being a mobile telephone.

39. A music, audio, or video data system that distributes files tagged with meta-data generated using the above method claim 1.

40. (canceled)

41. (canceled)
